(19) United States
(12) Patent Application Publication
(10) Pub. No.: US 2017/0234142 A1
(43) Pub. Date: Aug. 17, 2017

(54) Rotor Blade Trailing Edge Cooling

(71) Applicant: General Electric Company, Schenectady, NY (US)

(72) Inventors: Adebukola Oluwaseun Benson, Simpsonville, SC (US); Nicholas Alvin Hogberg, Greenville, SC (US); Xiuzhang James Zhang, Simpsonville, SC (US); Gary Michael Itzel, Simpsonville, SC (US); Mohankumar Banakar, Bangalore (IN)

(21) Appl. No.: 15/045,553

(22) Filed: Feb. 17, 2016

(51) Int. Cl. F01D 5/18; F02C 3/04

(52) U.S. Cl. CPC F01D 5/187; F02C 3/04; F05D 2220/32; F05D 2240/304; F05D 2240/80; F05D 2250/185

(57) ABSTRACT

The present disclosure is directed to a rotor blade for a gas turbine engine. The rotor blade includes a platform having a radially inner surface and a radially outer surface. A connection portion extends radially inwardly from the radially inner surface of the platform. An airfoil extends radially outwardly from the radially outer surface of the platform to an airfoil tip. The airfoil includes a leading edge portion and a trailing edge portion. The platform, the airfoil, and the connection portion collectively define a cooling circuit extending from an inlet defined by the connection portion to one or more outlet passages at least partially defined by the trailing edge portion of the airfoil. At least one of the one or more outlet passages include an entrance and an exit radially inwardly offset from the entrance.

### FIELD OF THE INVENTION

The present disclosure generally relates to a rotor blade for a gas turbine. More particularly, this disclosure relates to a cooling circuit for a rotor blade.

### BACKGROUND OF THE INVENTION

A gas turbine generally includes a compressor section, a combustion section, a turbine section, and an exhaust section. The compressor section progressively increases the pressure of a working fluid entering the gas turbine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a shaft connected, e.g., to a generator to produce electricity. The combustion gases then exit the gas turbine via the exhaust section.

The turbine section includes a plurality of turbine rotor blades, which extract kinetic energy and/or thermal energy from the combustion gases flowing therethrough. These rotor blades generally operate in extremely high temperature environments. In order to achieve adequate service life, the rotor blades typically include an internal cooling circuit. During operation of the gas turbine, a cooling medium such as compressed air is routed through the internal cooling circuit to cool the rotor blade.

In some configurations, the cooling medium may exit the cooling circuit through one or more passages in a trailing edge of the rotor blade. Nevertheless, conventional trailing edge cooling passage arrangements may produce undesirable thermal gradients in the rotor blade or otherwise insufficiently cool the rotor blade.

### BRIEF DESCRIPTION OF THE INVENTION

Aspects and advantages of the invention are set forth below in the following description, or may be obvious from the description, or may be learned through practice of the invention.

In one aspect, the present disclosure is directed to a rotor blade for a gas turbine engine. The rotor blade includes a platform having a radially inner surface and a radially outer surface. A connection portion extends radially inwardly from the radially inner surface of the platform. An airfoil extends radially outwardly from the radially outer surface of the platform to an airfoil tip. The airfoil includes a leading edge portion and a trailing edge portion. The platform, the airfoil, and the connection portion collectively define a cooling circuit extending from an inlet defined by the connection portion to one or more outlet passages at least partially defined by the trailing edge portion of the airfoil. At least one of the one or more outlet passages include an entrance and an exit radially inwardly offset from the entrance.

Another aspect of the present disclosure is directed to a gas turbine that includes a compressor section, a combustion section, and a turbine section. The turbine section includes one or more rotor blades. Each rotor blade includes a platform having a radially inner surface and a radially outer surface. A connection portion extends radially inwardly from the radially inner surface of the platform. An airfoil extends radially outwardly from the radially outer surface of the platform to an airfoil tip. The airfoil includes a leading edge portion and a trailing edge portion. The platform, the airfoil, and the connection portion collectively define a cooling circuit extending from an inlet defined in the connection portion to one or more outlet passages at least partially defined by the trailing edge portion of the airfoil. At least one of the one or more outlet passages include an entrance and an exit radially inwardly offset from the entrance.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic view of an exemplary gas turbine in accordance with the embodiments disclosed herein;

FIG. 2 is a perspective view of an exemplary rotor blade that may be incorporated in the gas turbine shown in FIG. 1 in accordance with the embodiments disclosed herein;

FIG. 3 is an alternate perspective view of the exemplary rotor blade shown in FIG. 2, further illustrating various features thereof;

FIG. 4 is a cross-sectional view of the exemplary rotor blade shown in FIGS. 2 and 3 taken generally about line 4-4 in FIG. 3, illustrating portions of a cooling circuit;

FIG. 5 is a cross-sectional view a trailing edge of the rotor blade shown in FIG. 4, illustrating one or more outlet passages defined thereby;

FIG. 6 is a cross-sectional view of a portion of the trailing shown in FIG. 5, illustrating two outlet passages and the relative diameters and angles of each;

FIG. 7 is a cross-sectional view of an alternate embodiment of the portion of the trailing shown in FIG. 6, illustrating two outlet passages and the relative angles of each;

FIG. 8A is a front view of one embodiment of one of the one or more outlet passages, illustrating a circular cross-section thereof;

FIG. 8B is a front view of an alternate embodiment of the one of the one or more outlet passages, illustrating an oval cross-section thereof;

FIG. 8C is a front view of another embodiment of one of the one or more outlet passages, illustrating a cross-section thereof having four straight portions; and

FIG. 8D is a front view of a further embodiment of one of the one or more outlet passages, illustrating a cross-section thereof having two straight portions.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although an industrial or land-based gas turbine is shown and described herein, the present invention as shown and described herein is not limited to a land-based and/or industrial gas turbine unless otherwise specified in the claims. For example, the invention as described herein may be used in any type of turbine including but not limited to a steam turbine or marine gas turbine.

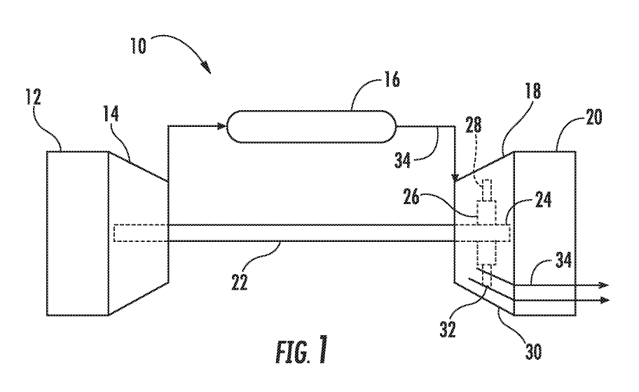

Now referring to the drawings, wherein identical numerals indicate the same elements throughout the figures, FIG. 1 schematically illustrates a gas turbine system 10. It should be understood that the turbine system 10 of the present disclosure need not be a gas turbine system 10, but rather may be any suitable turbine system, such as a steam turbine system or other suitable system. The gas turbine system 10 may include an inlet section 12, a compressor section 14, a combustion section 16, a turbine section 18, and an exhaust section 20. The compressor section 12 and turbine section 18 may be coupled by a shaft 22. The shaft 22 may be a single shaft or a plurality of shaft segments coupled together to form shaft 22.

The turbine section 18 may generally include a rotor shaft 24 having a plurality of rotor disks 26 (one of which is shown) and a plurality of rotor blades 28 extending radially outwardly from and interconnected to the rotor disk 26. Each rotor disk 26 in turn, may be coupled to a portion of the rotor shaft 24 that extends through the turbine section 18. The turbine section 18 further includes an outer casing 30 that circumferentially surrounds the rotor shaft 24 and the rotor blades 28, thereby at least partially defining a hot gas path 32 through the turbine section 18.

During operation, a working fluid such as air flows through the inlet section 12 and into the compressor section 14, where the air is progressively compressed to provide pressurized air to the combustors (not shown) in the combustion section 16. The pressurized air is mixed with fuel and burned within each combustor to produce combustion gases 34. The combustion gases 34 flow through the hot gas path 32 from the combustor section 16 into the turbine section 18, wherein energy (kinetic and/or thermal) is transferred from the combustion gases 34 to the rotor blades 28, thus causing the rotor shaft 24 to rotate. The mechanical rotational energy may then be used to power the compressor section 14 and/or to generate electricity. The combustion gases 34 exiting the turbine section 18 may then be exhausted from the gas turbine 10 via the exhaust section 20.

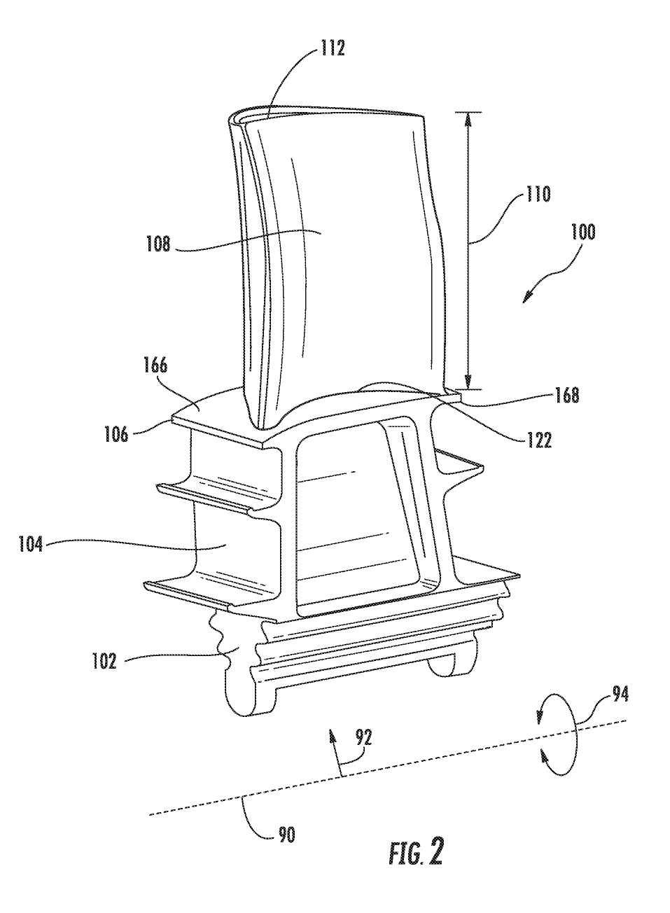

FIGS. 2-4 are various views of an exemplary rotor blade 100, which may incorporate one or more embodiments disclosed herein and may be incorporated into the turbine section 18 of the gas turbine 10 in place of rotor blade 28 as shown in FIG. 1. As illustrated in FIGS. 2-4, the rotor blade 100 defines an axial direction 90, a radial direction 92, and a circumferential direction 94. The radial direction 92 extends generally orthogonal to the axial direction 90, and the circumferential direction 94 extends generally concentrically around the axial direction 90.

As shown in FIG. 2, the rotor blade 100 generally includes a root portion 102, which extends radially inwardly from a shank portion 104. The root portion 102 may interconnect or secure the rotor blade 100 to the rotor disk 26 (FIG. 1). In some embodiments, for example, the root portion 102 may have a dovetail configuration. The root portion 102 and the shank portion 104 may collectively be referred to as the connection portion of the rotor blade 100.

As best illustrated in FIGS. 2-4, the rotor blade 100 includes a platform 106, which generally serves as a radially inward flow boundary for the combustion gases 34 flowing through the hot gas path 32 of the turbine section 18 (FIG. 1). More specifically, the platform 106 includes a radially inner surface 168 radially spaced apart from a radially outer surface 166. The radially inner surface 168 of the platform 106 couples to the shank 104. As such, the shank 104 extends radially inwardly from the radially inner surface 168 of the platform 106. The platform 106 also includes a leading edge portion 126 axially spaced apart from a trailing edge portion 128. The leading edge portion 126 is positioned into the flow of combustion gases 34, and the trailing edge portion 128 is positioned downstream from the leading edge portion 126. Furthermore, the platform 106 includes a pressure-side slash face 130 circumferentially spaced apart from a suction-side slash face 132.

The rotor blade 100 further includes an airfoil 108 that extends radially outwardly from the platform 106 to an airfoil tip 112. As such, the airfoil tip 112 may generally define the radially outermost portion of the rotor blade 100. The airfoil 108 connects to the platform 106 at an airfoil root 122 (i.e., the intersection between the airfoil 108 and the platform 106). In some embodiments, the airfoil root 122 may include a radius or fillet 124 that transitions between the airfoil 108 and the platform 106. In this respect, the airfoil 108 defines an airfoil span 110 extending between the airfoil root 122 and the airfoil tip 112. The airfoil 100 also includes a pressure-side wall 114 and an opposing suction-side wall 116. The pressure-side wall 114 and the suction-side wall 116 are joined together or interconnected at a leading edge portion 118 of the airfoil 108, which is oriented into the flow of combustion gases 34. The pressure-side wall 114 and the suction-side wall 116 are also joined together or interconnected at a trailing edge portion 120 of the airfoil 108, which is spaced downstream from the leading edge portion 118. The pressure-side wall 114 and the suction-side wall 116 are continuous about the leading edge portion 118 and the trailing edge portion 120. The pressure-side wall 114 is generally concave, and the suction-side wall 116 is generally convex.

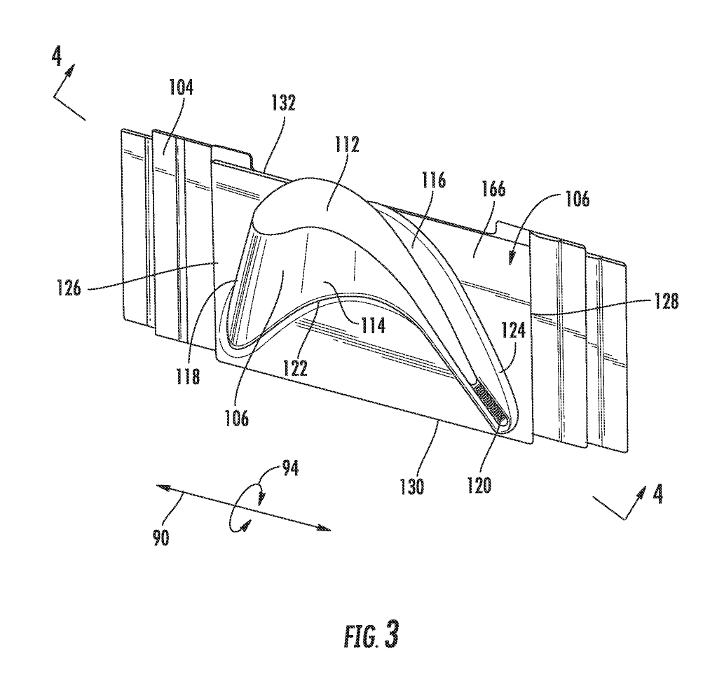

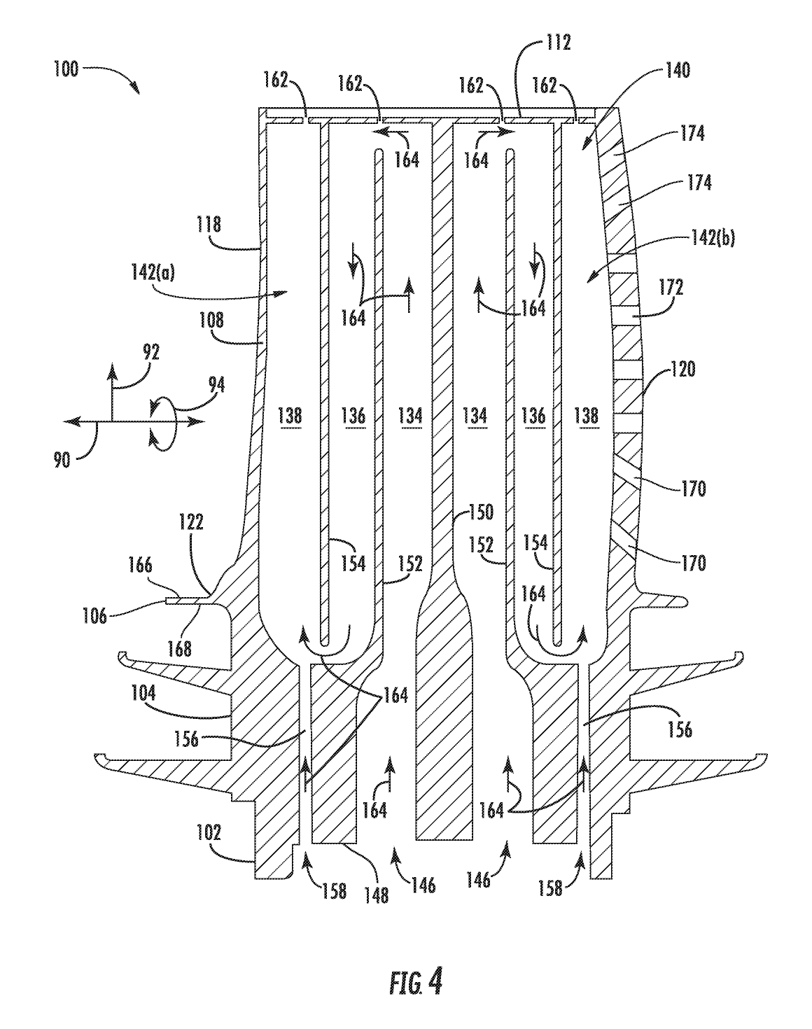

Referring to FIG. 4, the rotor blade 100 defines a cooling circuit 140. More specifically, the cooling circuit 140 includes one or more inlet plena 146 defined by the root portion 102 and/or the shank portion 104. The one or more inlet plena 146 supply a cooling medium (e.g., compressed air bled from the compressor section 14) to one or more serpentine passages 142 defined by the airfoil 108, the platform 106, and/or the shank portion 104. The cooling medium flows from at least one of the one or more serpentine passages 142 into one or more outlet passages (e.g., one or more radially inwardly angled outlet passages 170, one or more radially straight outlet passages 172, and/or one or more radially outwardly angled outlet passages 174) defined by the trailing edge portion 120 of the airfoil 108. The cooling medium exits the rotor blade 100 through the one or more outlet passages 170, 172, 174 into the hot gas path 32 (FIG. 1). In this respect, the cooling medium flows through the root portion 102, the shank portion 104, the platform 106, and the airfoil 108.

FIG. 4 illustrates one embodiment of the cooling circuit 140 that includes a first or forward serpentine passage 142(a) and a second or aft serpentine passage 142(b) axially separated from the first serpentine passage 142(a) by a first wall 150. Although, the cooling circuit 140 may include more or less serpentine passages 142 as is necessary or desired. Each of the first and the second serpentine passages 142(a), 142(b) includes a first or inner channel 134 in fluid communication with the inlet plenum 146. A second or central channel 136 fluidly couples to the first channel 134 proximate the airfoil tip 112. In this respect, a second wall 152 extending radially outwardly from the shank portion 104 separates the first and the second channels 134, 136. A third or outer channel 138 fluidly couples to the second channel 136 proximate the shank portion 104. As such, a third wall 154 extending radially inwardly from the airfoil tip 112 separates the second and the third channels 136, 138. The third channel 136 of the second serpentine passage 142(b) is in fluid communication with the one or more outlet passages 170, 172, 174. The third channel 138 of the first serpentine passage 142(a) may be in fluid communication with the one or more outlets (not shown) defined by the platform 106. In other embodiments, the first and the second serpentine passages 142(a), 142(b) may include more or less channels as is necessary or desired and may have other configurations as well.

The serpentine passages 142 may optionally include other features as well. For example, each of the first and/or the second serpentine passages 142(a), 142(b) may optionally include a refresher passageway 156 fluidly coupled to the third channel 138. The refresher passageway 156 receives fresh cooling medium via an inlet 158 and provides this fresh cooling medium to third channel 138. In some embodiments, the first and/or second serpentine passages 142(a), 142(b) may be in fluid communication with one or more outlet ports 162 defined by the airfoil tip 112 or one or more outlets (not shown) defined by the platform 106.

The cooling medium, such as cooling air 164, flows through the first and the second serpentine passages 142(a), 142(b) of the cooling circuit 140 to cool the rotor blade 100. More specifically, the cooling air 164 enters the inlet plena 164 of the first and the second serpentine passages 142(a), 142(b). The cooling flow 164 flows radially outwardly through the first channels 134 in each of the first and the second serpentine passages 142(a), 142(b). The cooling air 164 then enters the second channels 136, where the cooling air 164 flows radially inward. The cooling air 164 then flows radially outwardly in the third channels 138. The cooling air 164 may also enter the third channels 138 through the refresher passageways 156 if included. The cooling air 164 then exits the second serpentine passage 142(b) through the one or more outlet passages 170, 172, 174 defined by the trailing edge portion 120 of the airfoil 108 and optionally through the outlet ports 162 in the airfoil tip 112 and/or the outlets in the platform 106. The cooling air 164 may exit the first serpentine passage 142(a) through the outlet ports 162 in the airfoil tip 112 and/or the outlets in the platform 106.

FIG. 5 illustrates one embodiment of the trailing edge portion 120 of the airfoil 108, which includes the one or more radially inwardly angled outlet passages 170, the one or more radially straight outlet passages 172, and/or the one or more radially outwardly angled outlet passages 174. More specifically, the trailing edge portion 120 illustrated in FIG. 5 includes three radially inwardly angled outlet passages 170, four radially straight outlet passages 172, and two radially outwardly angled outlet passages 174. Nevertheless, the trailing edge portion 120 may include more or less radially inwardly angled outlet passages 170, radially straight outlet passages 172, and/or radially outwardly angled outlet passages 174 as is necessary or desired. In fact, the trailing edge portion 120 may include any number of the radially inwardly angled outlet passages 170, the radially straight outlet passages 172, and the radially outwardly angled outlet passages 174 so long as the trailing edge portion 120 includes at least one radially inwardly angled outlet passage 170. Including at least one radially inwardly angled outlet passage 170 that extends through the trailing edge portion 120 improves the cooling of the rotor blade 100 and creates more desirable thermal gradients in the platform 106.

In some embodiments, the one or more radially inwardly angled outlet passages 170 are positioned radially inward from the one or more radially straight outlet passages 172, which are positioned radially inward from the one or more radially outwardly angled outlet passages 174. As illustrated in FIG. 5, for example, the three radially inwardly angled outlet passages 170 are positioned radially inwardly from the four radially straight outlet passages 172. Furthermore, the four radially straight outlet passages 172 are positioned radially inwardly of the two radially outwardly angled outlet passages 174. The radially innermost outlet passage in some embodiments is the one of the radially inwardly angled outlet passages 170. In fact, one or more of the radially inwardly angled outlet passages 170 may be partially defined by and extend through the radius 124 and/or the platform 106 in some embodiments as illustrated in FIG. 5. Nevertheless, the radially inwardly angled outlet passages 170, the radially straight outlet passages 172, and the radially outwardly angled outlet passages 174 may be arranged radially along the trailing edge portion 120 in any suitable manner or arrangement.

As illustrated in FIGS. 5-7, each of the outlet passages 170, 172, 174 extend between an entrance defined by an inner surface 160 of the trailing edge portion 120 and an exit defined by an outer surface 144 of the trailing edge portion 120. More specifically, each of the one or more radially inwardly angled outlet passages 170 extends between an entrance 176 defined by the inner surface 160 and an exit 178 defined by the outer surface 144 at a radially inward angle. In this respect, the exit 178 is radially inwardly offset from the entrance 176. Each of the one or more radially straight outlet passages 172 extends between an entrance 180 defined by the inner surface 160 and an exit 182 defined by the outer surface 144 in a manner such that the exit 182 is radially aligned with the entrance 180. Each of the one or more radially outwardly angled outlet passages 174 extends between an entrance 184 defined by the inner surface 160 and an exit 186 defined by the outer surface 144 at a radially outward angle. In this respect, the exit 178 is radially outwardly offset from the entrance 176.

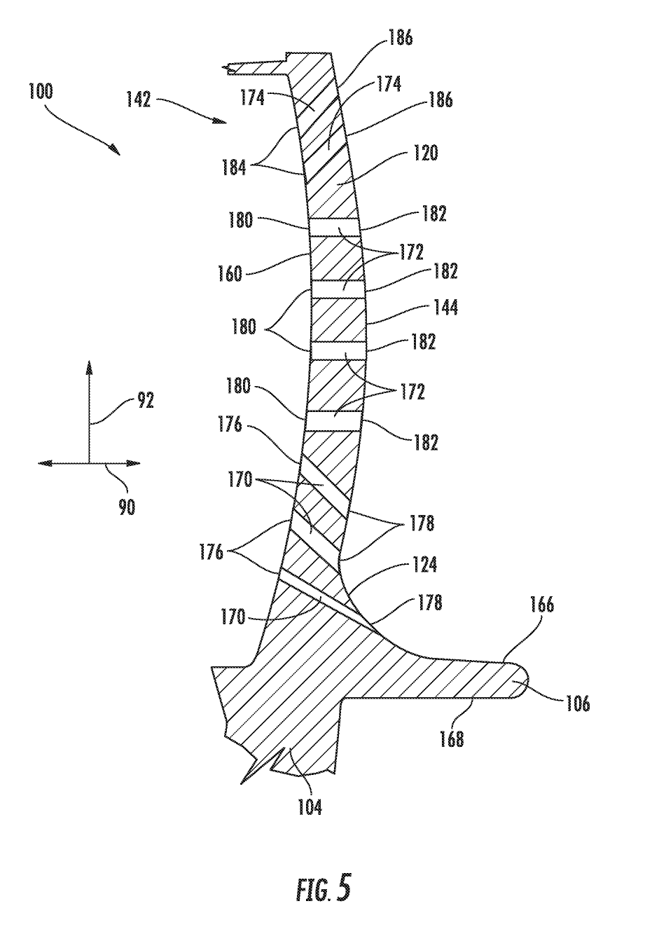

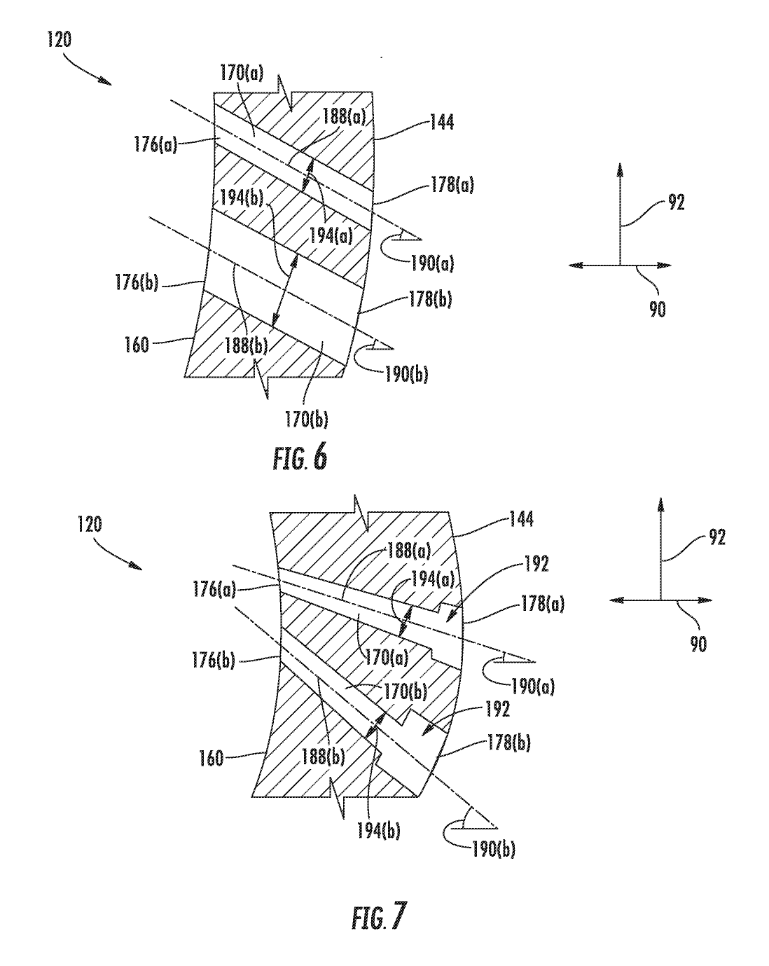

FIGS. 6 and 7 show embodiments of the relative orientation of the outlet passages 170 with respect to each other. More specifically, FIGS. 6 and 7 illustrate a first radially inwardly angled outlet passage 170(a) extending along a first centerline 188(a) between a first entrance 176(a) and a first exit 178(a) at a first radially inward angle 190(a). Furthermore, a second radially inwardly angled outlet passage 170(b) extends along a second centerline 188(b) between a second entrance 176(b) and a second exit 178(b) at a second radially inward angle 190(b). In the embodiment shown in FIG. 6, the angles 190(a) and 190(b) are the same. Nevertheless, the angles 190(a) and 190(b) in the embodiment shown in FIG. 7 are different. In some embodiments, the angles 190(a), 190(b), etc. may decrease in increments in the radially outward direction (e.g., the angle 190(b) is two degrees greater than the angle 190(a) and the adjacent angle (not shown) radially inward of the angle 190(b) is four degrees greater than the angle 190(b), etc.).

The first and the second outlet passages 170(a), 170(b) respectively include a first diameter 194(a) and a second diameter 194(b). In the embodiment shown in FIG. 6, the first diameter 194(a) is different (i.e., shorter) than the second diameter 194(b). In the embodiment shown in FIG. 7, however, the first diameter 194(a) is the same as the second diameter 194(b).

One or more of the outlet passages 170 may define a coating collector 192 to prevent a coating (e.g., a thermal barrier coating) applied to the rotor blade 100 from obstructing the flow of cooling medium the one or more outlet passages 170. As illustrated in FIG. 7, the coating collector 192 is an enlarged cavity positioned circumferentially around exit 178 of the outlet passage 170 (i.e., similar to a counter-bore). In this respect, the coating collector 92 (i.e., the enlarged cavity) collects any excess coating that enters the outlet passages 170, thereby preventing the coating from blocking the outlet passages 170. Although the coating collector 192 is described above in the context of the outlet passages 170, each of the outlet passages 172, 174 may also include the coating collector 192 as well.

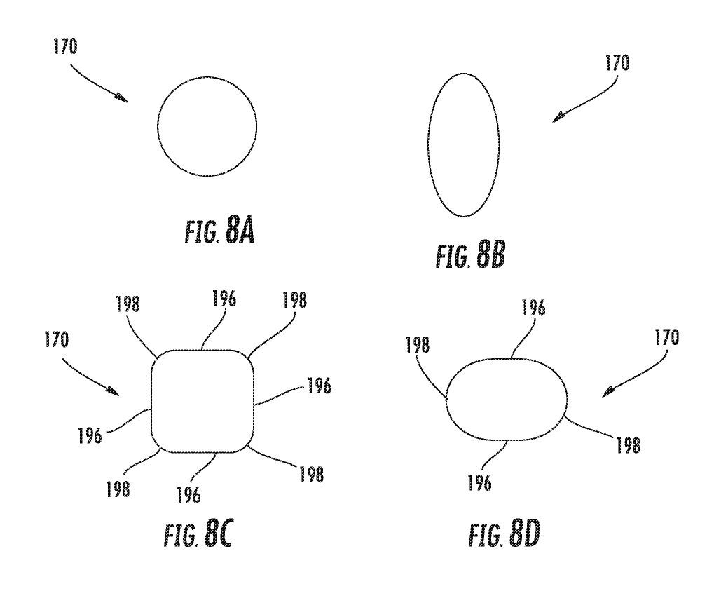

FIGS. 8A-8D illustrate several embodiments of the cross-sectional shape of the one or more outlet passages 170. The one or more outlet passages 172, 174 may also have similar cross-sections. More specifically, FIG. 8A illustrates one embodiment where the outlet passages 170 have a circular cross-section. FIG. 8B shows another embodiment where outlet passages 170 have an oval cross-section. FIG. 8C illustrates a third embodiment of the outlet passages 170. In this embodiment, the cross-section includes four straight portions 196 connected by four curved portions 198. As such, the cross-section is generally rectangular with curved corners. FIG. 8D illustrates a further embodiment of the outlet passages 170. The cross-section of this embodiment includes two straight portions 196 connected by two curved portions 198. In this respect, the cross-section appears as two hemispherical portions spaced apart by a rectangular portion. Nevertheless, the outlet passages 170 may have any suitable cross-section including any number of straight and/or curved portions 196, 198.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. A rotor blade for a gas turbine engine, comprising:
a platform comprising a radially inner surface and a radially outer surface;
a connection portion extending radially inwardly from the radially inner surface of the platform; and
an airfoil extending radially outwardly from the radially outer surface of the platform to an airfoil tip, the airfoil comprising a leading edge portion and a trailing edge portion;
wherein the platform, the airfoil, and the connection portion collectively define a cooling circuit extending from an inlet defined by the connection portion to one or more outlet passages at least partially defined by the trailing edge portion of the airfoil; and
wherein at least one of the one or more outlet passages comprises an entrance and an exit radially inwardly offset from the entrance.

2. The rotor blade of claim 1, wherein the one or more outlet passages comprise a plurality of outlet passages, and wherein one or more of the plurality of outlet passages are partially defined by and extend through a radius between the airfoil and the platform.

3. The rotor blade of claim 1, wherein the one or more outlet passages comprise a first outlet passage extending between a first entrance and a first exit at a first angle and a second outlet passage extending between a second entrance and a second exit at a second angle, and wherein the first angle and the second angle are the same.

4. The rotor blade of claim 1, wherein the one or more outlet passages comprise a first outlet passage extending between a first entrance and a first exit at a first angle and a second outlet passage extending between a second entrance and a second exit at a second angle, and wherein the first angle and the second angle are different.

5. The rotor blade of claim 1, wherein the one or more outlet passages comprise a plurality of outlet passages, and wherein at least two outlet passages of the plurality of outlet passages comprise different diameters.

6. The rotor blade of claim 1, wherein the one or more outlet passages comprises three or more outlet passages, and wherein one of the three or more outlet passages comprises an entrance and an exit radially outwardly offset from the entrance and another of the three or more outlet passages comprises an entrance and an exit radially aligned with the entrance.

7. The rotor blade of claim 6, wherein the outlet passage comprising the entrance and the exit radially outwardly offset from the entrance is positioned radially outwardly from the outlet passage comprising the entrance and the exit radially aligned with the entrance, and wherein the outlet passage comprising the entrance and the exit radially aligned with the entrance is positioned radially outwardly from the at least one outlet passage comprising the entrance and the exit radially inwardly offset from the entrance.

8. The rotor blade of claim 1, wherein the one or more outlet passages comprise a plurality of outlet passages, and wherein a radially innermost outlet passage of the plurality of outlet passages comprises an entrance and an exit radially inwardly offset from the entrance.

9. The rotor blade of claim 1, wherein at least one of the one or more outlet passages comprises a cross-sectional shape that is oval, elliptical, or includes one or more straight sides.

10. The rotor blade of claim 1, wherein at least one of the one or more outlet passages comprises a coating collector.

11. A gas turbine engine, comprising:
a compressor section;
a combustion section; and
a turbine section, comprising:
one or more rotor blades, each rotor blade comprising:
a platform comprising a radially inner surface and a radially outer surface;
a connection portion extending radially inwardly from the radially inner surface of the platform; and
an airfoil extending radially outwardly from the radially outer surface of the platform to an airfoil tip, the airfoil comprising a leading edge portion and a trailing edge portion;
wherein the platform, the airfoil, and the connection portion collectively define a cooling circuit extending from an inlet defined by the connection portion to one or more outlet passages at least partially defined by the trailing edge portion of the airfoil; and
wherein at least one of the one or more outlet passages comprises an entrance and an exit radially inwardly offset from the entrance.

12. The gas turbine of claim 11, wherein the one or more outlet passages comprise a plurality of outlet passages, and wherein one or more of the plurality of outlet passages are partially defined by and extend through the platform.

13. The gas turbine of claim 11, wherein the one or more outlet passages comprise a first outlet passage extending between a first entrance and a first exit at a first angle and a second outlet passage extending between a second entrance and a second exit at a second angle, and wherein the first angle and the second angle are the same.

14. The gas turbine of claim 11, wherein the one or more outlet passages comprises a first outlet passage extending between a first entrance and a first exit at a first angle and a second outlet passage extending between a second entrance and a second exit at a second angle, and wherein the first angle and the second angle are different.

15. The gas turbine of claim 11, wherein the one or more outlet passages comprise a plurality of outlet passages, and wherein at least two outlet passages of the plurality of outlet passages comprise different diameters.

16. The gas turbine of claim 11, wherein the one or more outlet passages comprises three or more outlet passages, and wherein one of the three or more outlet passages comprise an entrance and an exit radially outwardly offset from the entrance and another of the three or more outlet passages comprises an entrance and an exit radially aligned with the entrance.

17. The gas turbine of claim 16, wherein the outlet passage comprising the entrance and the exit radially outwardly offset from the entrance is positioned radially outwardly from the outlet passage comprising the entrance and the exit radially aligned with the entrance, and wherein the outlet passage comprising the entrance and the exit radially aligned with the entrance is positioned radially outwardly from the at least one outlet passage comprising the entrance and the exit radially inwardly offset from the entrance.

18. The gas turbine of claim 11, wherein the one or more outlet passages comprise a plurality of outlet passages, and wherein a radially innermost outlet passage of the plurality of outlet passages comprises an entrance and an exit radially inwardly offset from the entrance.

19. The gas turbine of claim 11, wherein at least one of the one or more outlet passages comprises a cross-sectional shape that is oval, elliptical, or includes one or more straight sides.

20. The gas turbine of claim 11, wherein at least one of the one or more outlet passages comprises a coating collector.
